(19) United States
(12) Patent Application Publication
(10) Pub. No.: US 2018/0201086 A1
(43) Pub. Date: Jul. 19, 2018

(54) CONNECTING STRUCTURE WHICH REDUCES VIBRATION EFFECT OF POWER SYSTEM ON VEHICLE BODY

(71) Applicant: CHONGQING HIJOY INDUSTRY GROUP CO., LTD, Yubei District Chongqing (CN)

(72) Inventor: Gengshu Ran, Yubei District Chongqing (CN)

(21) Appl. No.: 15/739,897

(22) PCT Filed: Aug. 25, 2016
(86) PCT No.: PCT/CN2016/096693

§ 371 Date: Dec. 26, 2017

(30) Foreign Application Priority Data
Jun. 26, 2015 (CN) 201510361810.4

(51) Int. Cl. B60G 21/055; B60K 5/12

(52) U.S. Cl. CPC B60G 21/0551; B60G 2600/44; B60K 5/12

(57) ABSTRACT

A connecting structure which reduces a vibration effect of a power system on a vehicle body comprises a power system bracket, one end of the power system bracket being connected to a power system, another end being connected to a suspension, one end of the suspension being connected to a frame or a load-bearing vehicle body, another end being connected to an axle or wheels, the suspension being capable of attenuating and isolating high frequency vibrations produced by the power system. The power system is not directly connected to the vehicle body which is above shock absorbers, but rather connected to a suspension frame which is below the shock absorbers, extending the path whereby power system high frequency vibration energy is transferred to the vehicle body, so that the high frequency vibrations of the power system are effectively attenuated and isolated, and the vibrations of the vehicle body are reduced.

### TECHNICAL FIELD

The present invention relates to a connecting structure and particularly relates to a connecting structure which reduces a vibration effect of a power system on a vehicle body.

### BACKGROUND

A traveling system of a motor vehicle is generally composed of a frame (or a load-bearing vehicle body), an axle (front and rear axles), wheels, a suspension (front and rear suspensions) and the like, is used for receiving a torque transferred by a driving system from a power system and producing a tractive force for the motor vehicle under an adhesive action between driving wheels and a road surface to ensure the normal travel of the motor vehicle, alleviate vehicle body impact and vibrations caused by the uneven road surface as much as possible and ensure the traveling smoothness of the motor vehicle and is matched with a motor vehicle steering system to ensure the operation stability of the motor vehicle.

The suspension is a general name of all force transferring and connecting devices between the frame (or the load-bearing vehicle body) and the axle (or wheels) of the motor vehicle and has the functions of transferring a force and a torque which are acted on the wheels and the vehicle body and buffering an impact force transferred to the vehicle body by the uneven road surface to reduce vibrations caused thereby so as to ensure that the motor vehicle can smoothly travel. A typical suspension is structurally composed of an elastic mechanism, a guide mechanism, shock absorbers and the like, and an individual structure is also provided with a buffer block, a transverse stabilizer bar and the like.

The power system (comprising an engine assembly and a differential assembly) of each of traditional three-wheeled and four-wheeled motor vehicles is connected to the frame (or the load-bearing vehicle body) by a power system bracket (comprising a front bracket and a rear bracket), and a static load and a dynamic load of the power system are both located on the shock absorbers, and the driving wheels (front wheel drive, rear wheel drive or front and rear wheel synchronous drive) are connected together by the axle and the suspension or are directly connected by the suspension and the frame (or the load-bearing vehicle body). The existing structure has the defects that the flexible buffer capacities of buffer structures such as the shock absorbers and suspended rubber jackets in the suspension as well as tyres of the driving wheels only aim at absorbing and isolating low frequency vibrations produced on the vehicle body by road bumping, but not isolating and attenuating high frequency vibrations produced by the power system (particularly single-cylinder and double-cylinder engines) at the same time, so that the high frequency vibrations produced by the power system are directly transferred to the vehicle body to result in discomfortness of a driver and passengers, such as numbness feeling brought for feet, the hip and the back by the high frequency vibrations.

In addition, the existing suspended rubber jacket mainly comprises an outer iron ring, an inner iron ring and a rubber mat arranged between the outer iron ring and the inner iron ring, and the suspended rubber jacket is easily pressed to be tight by the inner iron ring and the outer iron ring under the affect of gravity so as to have a relatively poor shock absorption effect.

### SUMMARY

The present invention aims at providing a connecting structure which reduces a vibration effect of a power system on a vehicle body to improve comfortable sensations of a driver and passengers.

In order to achieve the aim, the specific technical scheme of the connecting structure which reduces the vibration effect of the power system on the vehicle body is as follows:
the connecting structure which reduces the vibration effect of the power system on the vehicle body comprises a power system bracket, one end of the power system bracket is connected to the power system, the other end is connected to a suspension, one end of the suspension is connected to a frame or a load-bearing vehicle body, the other end is connected to an axle or wheels, and the suspension is capable of attenuating and isolating high frequency vibrations produced by the power system.

Disclosed is a motor vehicle comprising the connecting structure.

The connecting structure which reduces the vibration effect of the power system on the vehicle body has the following advantages.
1) A static load and a dynamic load of the power system in the present invention are not located on the vehicle body on shock absorbers, but rather located on a suspension frame below the shock absorbers. The structure extends the path whereby the high frequency vibration energy of the power system is transferred to the vehicle body, so that the high frequency vibrations of the power system are effectively attenuated and isolated, and the vibrations of the vehicle body are significantly reduced.
2) The static load and the dynamic load of the power system in the present invention are transferred from the vehicle body on the shock absorbers to the suspension frame below the shock absorbers, so that the center of gravity of the vehicle is lowered, the traveling stability of the vehicle is improved, vehicle body resonance produced under a combined action of road surface bumping and the vibrations of the power system is also effectively improved, and furthermore, the comfortable sensations of the driver and the passengers are significantly improved.
3) Due to the arrangement of a buffer assembly between the power system bracket and the suspension frame in the present invention, the high frequency vibrations produced by the power system can be isolated by the buffer assembly, so that the buffer effect is further improved.

### BRIEF DESCRIPTION OF THE DRAWINGS

FIG. 1 is an upward view of a three-wheeled motor vehicle according to a first embodiment of the present invention;

FIG. 2 is a schematic diagram of a connecting structure which reduces a vibration effect of a power system on a vehicle body in FIG. 1;

FIG. 3 is an upward view of a four-wheeled motor vehicle according to a second embodiment of the present invention;

FIG. 4 is a schematic diagram of the connecting structure which reduces the vibration effect of the power system on the vehicle body in FIG. 3;

FIG. 5 is an upward view of a motor vehicle according to a third embodiment of the present invention;

FIG. 6 is an inclined axonometric drawing of the motor vehicle according to the third embodiment of the present invention;

FIG. 7 is a local inclined rear view of the motor vehicle in FIG. 5;

FIG. 8 is a local forward rear view of the motor vehicle in FIG. 5;

FIG. 9 is a local front view of the motor vehicle in FIG. 5;

FIG. 10 is an inclined axonometric drawing of a motor vehicle with a power system being arranged at the rear according to a fourth embodiment of the present invention;

FIG. 11 is a local rear view of the motor vehicle in FIG. 10;

FIG. 12 is an upward view of a motor vehicle with a power system being arranged in the front according to a fifth embodiment of the present invention;

FIG. 13 is a local rear view of the motor vehicle in FIG. 12; and

FIG. 14 is a schematic structural diagram of a clamping rubber block adopted in each of the motor vehicles shown as FIG. 5-6, FIG. 10 and FIG. 12.

### DETAILED DESCRIPTION

In order to better know about the purpose, structure and functions of the present invention, a connecting structure which reduces a vibration effect of a power system on a vehicle body is further described in detail below in conjunction with the drawings.

The connecting structure which reduces the vibration effect of the power system on the vehicle body comprises a power system bracket, wherein one end of the power system bracket is connected to the power system, the other end is connected to a suspension, one end of the suspension is connected to a frame or a load-bearing vehicle body, the other end is connected to an axle or wheels, and the suspension is capable of attenuating and isolating high frequency vibrations produced by the power system. It should be noted that the power system in the present invention comprises an engine assembly and a differential assembly.

Therefore, the power system in the present invention is not directly connected to the vehicle body which is on shock absorbers, but rather connected to a suspension frame which is below the shock absorbers, so that the path whereby power system high frequency vibration energy is transferred to the vehicle body is extended, the high frequency vibrations of the power system are effectively attenuated and isolated, and the vibrations of the vehicle body are significantly reduced.

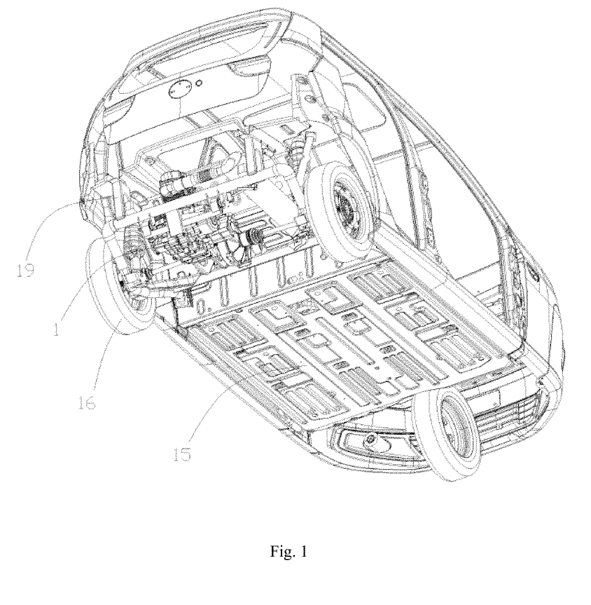

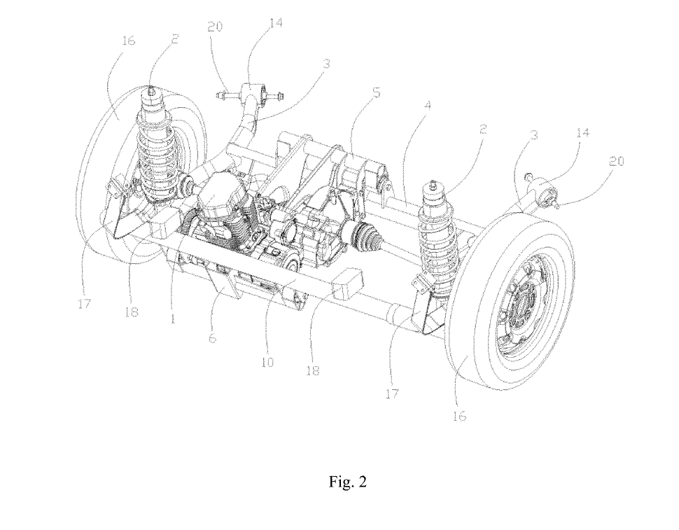

FIG. 1 and FIG. 2 are schematic diagrams of a three-wheeled motor vehicle applying the connecting structure. It should be noted that the three-wheeled motor vehicle in the embodiment adopts a rear-engine rear-drive form, and the vehicle body is the load-bearing vehicle body.

Further, as shown in FIG. 2, in the embodiment, the suspension comprises the suspension frame and the shock absorbers 2, wherein the first end of the suspension frame is connected to the load-bearing vehicle body 15 by rotary auxiliary shafts 20, and the second end is connected to the wheels 16; and the upper ends of the shock absorbers 2 are connected to the load-bearing vehicle body 15, the lower ends are connected to the second end of the suspension frame, and the power system bracket is connected to the suspension frame. In addition, it should be noted that the embodiment is described by an example in which the suspension is connected to the load-bearing vehicle body and the wheels, and the structural form that the suspension is connected to the frame and the axle can refer to the existent setting, but is no longer described in detail.

Further, the suspension frame comprises swaying arms 3 at two sides and a torsion beam 4 connected between the swaying arms 3 at two sides, wherein the first ends of the swaying arms 3 at two sides are connected to the load-bearing vehicle body 15 by rotary auxiliary shafts 20, and the second ends are connected to the bottom ends of the shock absorbers 2 and the wheels 16. In addition, a stabilizer bar can also be connected between the second ends of the swaying arms 3 at two sides in order to improve the stability of the suspension and the power system.

Further, the power system bracket comprises a first bracket 5 and a second bracket 6, wherein one end of the power system 1 is connected to the torsion beam 4 by the first bracket 5, and the other end is connected to the stabilizer bar 10 by the second bracket 6. It should be noted that one end of the power system 1 can be directly connected to the second ends of the swaying arms 3 at two sides by the second bracket 6 if the stabilizer bar 10 is not arranged between the second ends of the swaying arms 3 at two sides.

Further, buffer assemblies 14 such as suspended rubber jackets or clamping rubber blocks can be respectively arranged at the connection of the power system and the power system bracket, the connection of the power system bracket and the suspension frame and the connection of the suspension frame and each of the rotary auxiliary shafts to further attenuate vibrations produced by the power system 1.

Therefore, the vibrations produced by the power system in the present invention can be sequentially attenuated by the buffer assembly between the power system and the power system bracket, the buffer assembly between the power system bracket and the suspension frame, the buffer assembly between the suspension frame and each of the rotary auxiliary shafts, the shock absorbers and the like, so that the path whereby the high frequency vibration energy of the power system is transferred to the vehicle body is extended, the high frequency vibrations of the power system are effectively attenuated and isolated, and the vibrations of the vehicle body are significantly reduced.

Further, safety pulling belts 17 can also be arranged between the suspension and the load-bearing vehicle body 15, wherein one end of each of the safety pulling belts 17 is connected to the suspension frame, the other end is connected to the load-bearing vehicle body 15 and is arranged close to each of the shock absorbers 2, and the length of each of the safety pulling belts 17 can be equal to the stretching limit length of each of the shock absorbers 2. Therefore, when the shock absorbers 2 are in a stretching state and the stretching length reaches a stretching limit value in a traveling process of the motor vehicle, the safety pulling belts can prevent the stretching lengths of the shock absorbers from exceeding the stretching limit value so as to avoid the occurrence of sudden vehicle turnover accidents due to the fact that the stretching lengths of the shock absorbers exceed the stretching limit value.

Further, an anti-torsion assembly can also be arranged between the suspension and the load-bearing vehicle body 15. As shown in FIG. 1 and FIG. 2, the anti-torsion assembly comprises lower stop blocks 18 and upper stop blocks 19 which are correspondingly arranged, wherein the lower stop blocks 18 are arranged on the suspension frame, and the upper stop blocks 19 are arranged on the load-bearing vehicle body 15. When the relative left-right torsional pendulum quantity of the suspension and the load-bearing vehicle body 15 approaches to a critical value in the traveling process of the motor vehicle, the lower stop blocks 18 and the upper stop blocks 19 can be mutually stopped to play an anti-torsion role, so that an accident that the rotary auxiliary shafts 20 are broken due to the fact that the relative torsional pendulum quantity exceeds the critical value is avoided.

It should be noted that, in the embodiment, the lower stop blocks 18 are respectively located at the left and right sides of the stabilizer bar 10 at the second end of the suspension frame and are close to the swaying arms 3; and the upper stop blocks 19 are respectively arranged at the bottom of the load-bearing vehicle body 15 corresponding to the lower stop blocks 18. When the stabilizer bar is not arranged between the second ends of the swaying arms 3 at two sides, the lower stop blocks 18 can be directly arranged at the second ends of the swaying arms 3 at two sides; and the upper stop blocks 19 are arranged at the bottom of the load-bearing vehicle body 15 corresponding to the upper stop blocks 19.

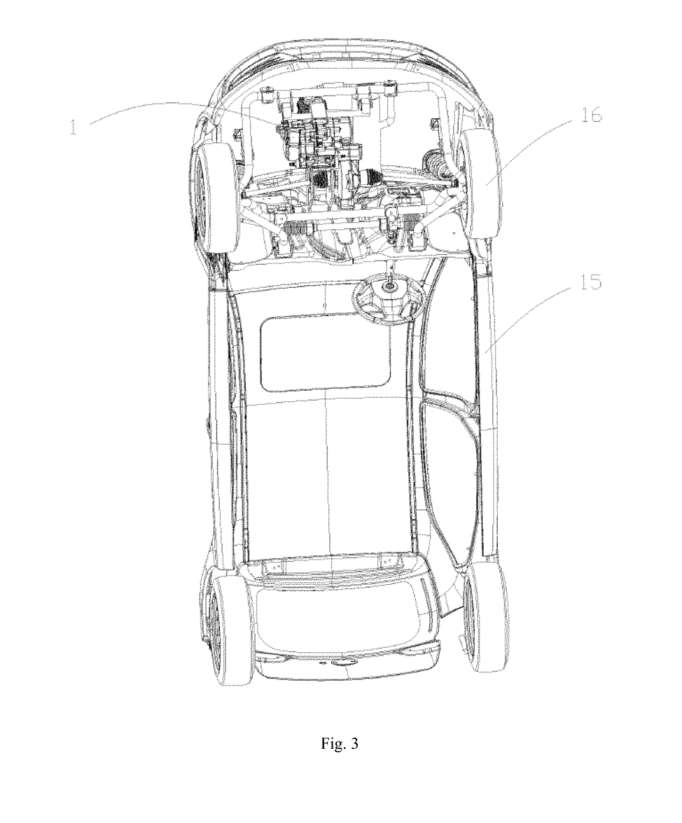

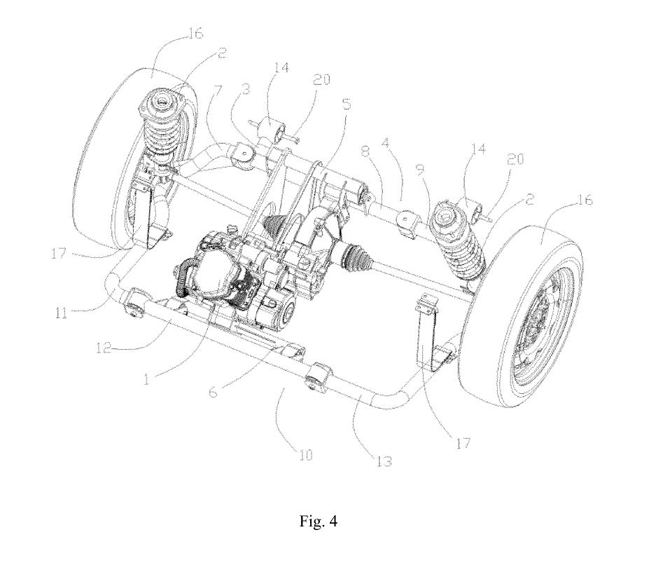

FIG. 3 and FIG. 4 are schematic diagrams of a four-wheeled motor vehicle applying the connecting structure. It should be noted that the four-wheeled motor vehicle in the embodiment adapts a front-engine front-drive form, and the vehicle body is the load-bearing vehicle body.

Further, as shown in FIG. 4, in the embodiment, the suspension comprises the suspension frame and the shock absorbers 2, wherein the first end of the suspension frame is connected to the load-bearing vehicle body 15 by the rotary auxiliary shafts 20, and the second end is connected to the wheels 16; and the upper ends of the shock absorbers 2 are connected to the load-bearing vehicle body 15, the lower ends are connected to the second end of the suspension frame, and the power system bracket is connected to the suspension frame.

Further, the suspension frame comprises the swaying arms 3 at two sides and the torsion beam 4 connected between the swaying arms 3 at two sides, wherein the first ends of the swaying arms 3 at two sides are connected to the load-bearing vehicle body 15 by the rotary auxiliary shafts 20, and the second ends are connected to the bottom ends of the shock absorbers and the wheels 16. In addition, in order to reduce the mutual interference of the wheels at two sides, as shown in FIG. 4, in the embodiment, the torsion beam 4 comprises a left section 7 of the torsion beam, a middle section 8 of the torsion beam and a right section 9 of the torsion beam which are connected sequentially, wherein one end of the left section 7 of the torsion beam is connected to the swaying arm 3 at one side, the other end is movably connected to the middle section 8 of the torsion beam (for example, by one of the suspended rubber jackets), one end of the right section 9 of the torsion beam is connected to the swaying arm 3 at the other side, and the other end is movably connected to the middle section 8 of the torsion beam (for example, by one of the suspended rubber jackets).

In such a way, the left and right wheels can be made relatively independent during traveling, and the mutual interference is reduced, so that an effect of reducing the inclination and vibrations of the vehicle body is achieved. Meanwhile, vibrations from the power system can also be further attenuated by the structure. It should be noted that the torsion beam structure in the embodiment can also be applied to the former embodiments so as to achieve a better effect.

Further, the stabilizer bar 10 can also be connected between the second ends of the swaying arms 3 at two sides in order to improve the stability of the suspension and the power system. In order to reduce the mutual interference of the wheels at two sides, as shown in FIG. 4, the stabilizer bar 10 comprises a left section 11 of the stabilizer bar, a middle section 12 of the stabilizer bar and a right section 13 of the stabilizer bar which are connected sequentially, wherein one end of the left section 11 of the stabilizer bar is connected to the second end of the swaying arm 3 at one side, the other end is movably connected to the middle section 12 of the stabilizer bar (for example, by one of the suspended rubber jackets), one end of the right section 13 of the stabilizer bar is connected to the second end of the swaying arm 3 at the other side, and the other end is movably connected to the middle section 12 of the stabilizer bar (for example, by one of the suspended rubber jackets). It should be noted that the structure of the stabilizer bar in the embodiment can also be applied to the former embodiments so as to achieve a better effect.

Further, the power system bracket comprises the first bracket 5 and the second bracket 6, wherein one end of the power system 1 is connected to the middle section 8 of the torsion beam 4 by the first bracket 5, and the other end is connected to the middle section 12 of the stabilizer bar 10 by the second bracket 6. It should be noted that one end of the power system 1 can be directly connected to the second ends of the swaying arms 3 at two sides by the second bracket 6 if the stabilizer bar 10 is not arranged between the second ends of the swaying arms 3 at two sides.

Further, the buffer assemblies 14 such as the suspended rubber jackets or the clamping rubber blocks can be respectively arranged at the connection of the power system 1 and the power system bracket, the connection of the power system bracket and the suspension frame and the connection of the suspension frame and each of the rotary auxiliary shafts 20 to further attenuate the vibrations produced by the power system 1.

Therefore, the vibrations produced by the power system in the present invention can be sequentially attenuated by the buffer assembly between the power system and the power system bracket, the buffer assembly between the power system bracket and the suspension frame, the buffer assembly between the suspension frame and each of the rotary auxiliary shafts, the shock absorbers and the like, so that the path whereby the high frequency vibration energy of the power system is transferred to the vehicle body is extended, the high frequency vibrations of the power system are more effectively attenuated and isolated, and the vibrations of the vehicle body are significantly reduced.

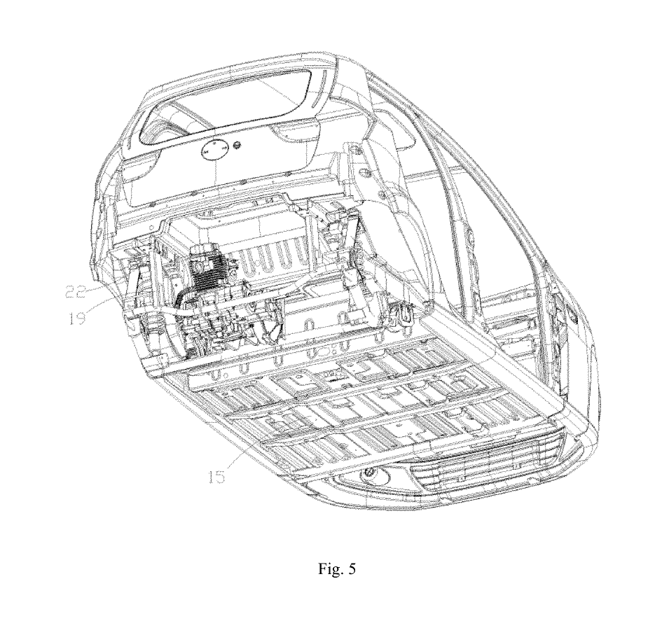

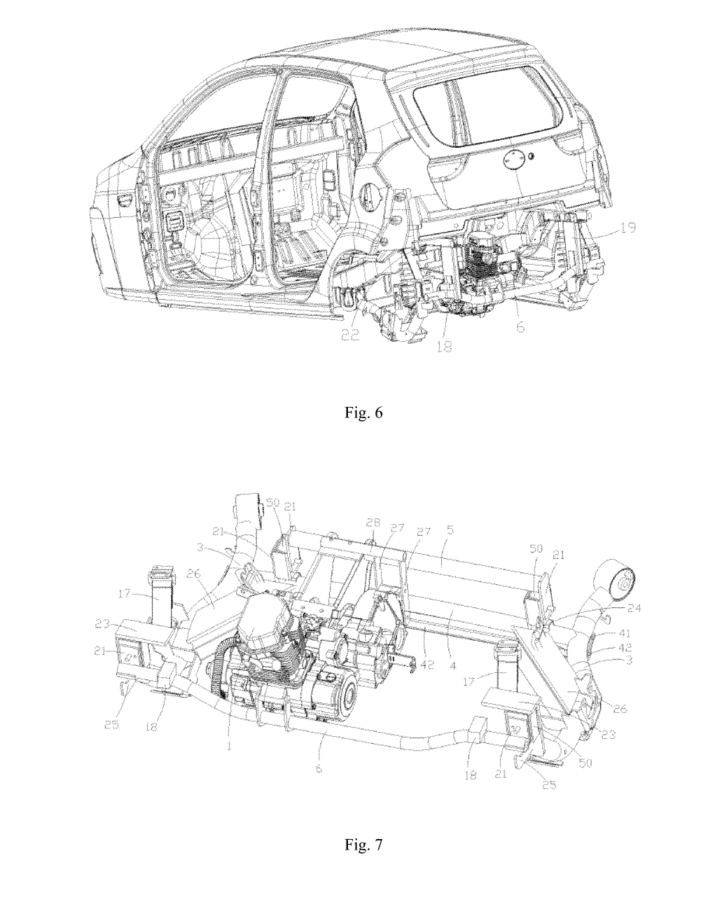

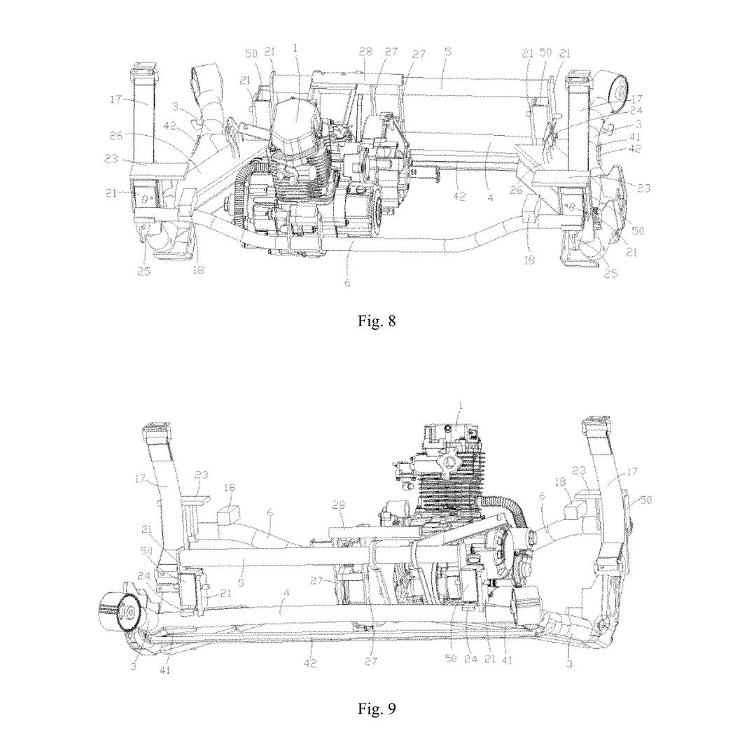

As shown in FIG. 5-9, disclosed is a motor vehicle according to a third embodiment of the present invention, compared with the first embodiment, the embodiment is mainly different in the structures and connecting way of the suspension frame and the power system bracket as well as the specific structure of the torsion beam, and rest parts can refer to those in the first embodiment, but are no longer described in detail.

As shown in FIG. 7-9, the power system bracket comprises the first bracket 5 and the second bracket 6, wherein one end of the power system 1 is connected to the torsion beam 4 by the first bracket 5, and the other end is directly connected to the second ends of the swaying arms 3 at two sides by the second bracket 6. In other words, the stabilizer bar is not arranged in the embodiment, but the second bracket 6 is configured to be directly connected to the second ends of the swaying arms 3 at two sides, and other force transferring parts are no longer arranged between the second bracket 6 and each of the second ends of the swaying arms 3 at two sides.

The torsion beam 4 is a rod-like body which bends upwards, and the torsion beam 4 preferably adopts a circular pipe form and is pressed to be shaped like an upwards-protruded arc, so that the bending resistance of the torsion beam 4 is improved. Two ends of the torsion beam 4 are respectively connected to the swaying arms 3 at two sides, the lower parts of two ends of the torsion beam 4 are also provided with bearing and receiving plates 41, and the bearing and receiving plates 41 are fixedly connected to the downsides of the torsion beam 4 and the swaying arms 3 so that the torsion beam 4 is fixedly connected to the swaying arms 3 at two sides.

Further, a force-bearing pulling belt 42 is arranged below the torsion beam 4, and ends at two sides of the force-bearing pulling belt 42 are respectively connected to ends at two sides of the torsion beam 4 to improve the bending resistance of the torsion beam. Specifically, the force-bearing pulling belt 42 is a strip-shaped plate, and two ends of the force-bearing pulling belt 42 are connected to downsides of the bearing and receiving plates 41 at two sides, for example, two ends of the force-bearing pulling belt 42 are connected to the bearing and receiving plates 41 and the swaying arms 3 in a welding way. Therefore, when the torsion beam 4 deforms downwards due to the overlarge up-down bumping range of the suspension in a process that the vehicle travels on a bumpy road surface, the torsion beam 4 can be rebounded to the original position under the action of the force-bearing pulling belt 42.

Different from the existing square torsion beam which is not sealed at the lower part, the torsion beam in the embodiment is preferably a square, trapezoidal or circular rod piece (such as a round pipe) which bends upwards and is sealed or unsealed at the lower part, and an auxiliary rod is also arranged below the torsion beam, so that the bending resistance of the torsion beam is greatly improved. Therefore, even if the power system is arranged on the torsion beam, both the torsional property and the bending resistance of the torsion beam can meet requirements. Conversely, the existing straight torsion beam can generate a downward bending phenomenon due to insufficient bending resistance to result in eccentric wear of tyres or other safety risks due to the fact that the outer inclination angles of the tyres are gradually reduced.

Further, as shown in FIG. 7, the differential assembly in the power system 1 is fixedly arranged on the suspension by two supporting rods 27, wherein one end of each of the two supporting rods 27 is connected to the differential assembly, the other end is fixedly arranged on the first bracket 5, for example, the other ends of the supporting rods 27 are connected to a connecting pipe or a connecting rod 28, the supporting rods 27 are fixedly arranged on the first bracket 5 by the connecting pipe or the connecting rod 28, and therefore, the up-down and left-right synchronous vibrations of the differential assembly and an engine can be realized by the structure, the damage of the differential assembly can be reduced, and the stability can be improved.

Further, two ends of the first bracket 5 are connected to the torsion beam 4 by the buffer assemblies, the second bracket 6 is a bracket rod, and two ends of the bracket rod are respectively connected to the swaying arms at two sides (such as the second ends of the swaying arms 3) by the buffer assemblies, wherein the buffer assemblies are vertically arranged at the connection of the first bracket 5 and the torsion beam 4 and the connection of the bracket rod and each of the swaying arms, and buffer materials of the buffer assemblies have certain vertical deformability or vertical freedom degrees so as to provide buffer in the connecting structure.

Therefore, the power system 1 is borne on the suspension frame composed of the swaying arms 3 at two sides and the torsion beam 4 by the first bracket 5 and the bracket rod, wherein the swaying arms 3 at two sides can relatively independently move or vibrate up and down in a vertical direction due to certain vertical deformability of the buffer assemblies, and the limit for the synchronous up-down vibrations of the swaying arms 3 at two sides is eliminated, so that bumping in the traveling process of an automobile is attenuated, and a more comfortable riding environment is provided for passengers.

As shown in FIG. 14, each of the buffer assemblies can be the clamping rubber block 50, wherein the clamping rubber block 50 comprises a cuboid buffer block 51 which can be made of a pressure-proof elastic material such as synthetic rubber or other materials. One side of the buffer block 51 is connected to a U-shaped connecting groove 52, two sides of the U-shaped connecting groove 52 are provided with barrier plates 521, and the other side of the buffer block 51 is connected to a connecting plate 53. The U-shaped connecting groove 52 and the connecting plate 53 are combined to be rectangular, and a relatively small distance is only spaced between each of the barrier plates 521 at two sides of the U-shaped connecting groove 52 and each of two sides of the connecting plate 53 so as to limit the lateral movement of the buffer block 51. One side of the connecting groove 52 and one side of the connecting plate 53 are provided with connecting rods or threaded rods 54 which can be connected to parts of the automobile, and the connecting groove 52 or the connecting plate 53 is also provided with a pin shaft 55 for preventing the buffer block 51 from rotating.

Further, two ends of the first bracket 5, two ends of the bracket rod, the second ends of the swaying arms 3 and the torsion beam 4 can be provided with connecting plates 21 of which the surfaces are provided with through holes. The connecting groove 52 or the connecting plate 53 at two sides of the clamping rubber block 50 is connected to the first bracket 5 and the torsion beam 4 at the connection of the first bracket 5 and the torsion beam 4 by using bolts, and the connecting groove 52 or the connecting plate 53 is vertically arranged. The connecting groove 52 or the connecting plate 53 at two sides of the clamping rubber block 50 is connected to the bracket rod and the swaying arms 3 at the connections of the bracket rod and the swaying arms 3 by using bolts, and the connecting groove 52 or the connecting plate 53 is vertically arranged.

The clamping rubber block 50 in the embodiment is firm in structure and has good vertical deformability, so that the limit for the synchronous up-down movement of the swaying arms 3 at two sides is eliminated. It should be noted that the clamping rubber block 50 in the present invention is arranged in the vertical direction, and the clamping rubber block 50 is not easily damaged due to a relatively small torsional force when being vertically arranged.

Further, a first limiting part 24 is also arranged at the connection of the first bracket 5 and the torsion beam 4 and is located below the clamping rubber block 50, and when the vertical deformation range of the clamping rubber block 50 is relatively wide due to the severe vibrations of the vehicle body, namely when the clamping rubber block 50 moves downwards, the first limiting part 24 can bear and receive the clamping rubber block 50 to limit the downward movement range of the clamping rubber block 50, so that the phenomenon that the clamping rubber block 50 is damaged due to excessive deformation is avoided.

Further, the connecting plates 21 of the swaying arms 3 are also provided with second limiting parts 25 located below the bracket rod. When the clamping rubber block 50 excessively deforms or is damaged, the second limiting parts 25 can be used for supporting or temporarily bearing the bracket rod to limit the downward movement range of the bracket rod, so that the phenomenon that the clamping rubber block 50 is damaged due to excessive deformation is avoided, or the power system 1 can be further supported when the clamping rubber block 50 is damaged.

Further, the frame or the load-bearing vehicle body (such as the bottom of the vehicle body) is provided with limiting rods 22, the bottom ends of the limiting rods 22 are provided with elastic blocks, the suspension frame is correspondingly provided with limiting rod baffles 23 which are preferably arranged on connection positions of the swaying arms 3 and the bracket rod so as to be arranged close to positions where vibration amplitudes are relatively large, for example, the limiting rod baffles 23 are directly fixedly arranged on the clamping rubber blocks 50 by which the swaying arms 3 are connected to the bracket rod. When the swaying arms 3 move upwards due to the bumping of the automobile in the traveling process of the automobile, the limiting rod baffles 23 can support against the elastic blocks at the bottom ends of the limiting rods 22 to limit the upward movement ranges of the swaying arms and avoid the phenomenon that the clamping rubber block 50 is damaged due to excessive deformation.

Further, an inclined plate 26 is arranged between the torsion beam 4 and each of the swaying arms 3 and is obliquely arranged in the suspension frame, one end of the inclined plate 26 is connected to the torsion beam 4, and the other end is connected to each of the swaying arms 3, so that the structural rigidity or firmness of the suspension frame is improved.

Further, the motor vehicle is also provided with the anti-torsion assembly comprising the lower stop blocks 18 and the upper stop blocks 19 which are correspondingly arranged, wherein the lower stop blocks 18 are arranged on the bracket rod, and the upper stop blocks 19 are arranged on the load-bearing vehicle body or the frame.

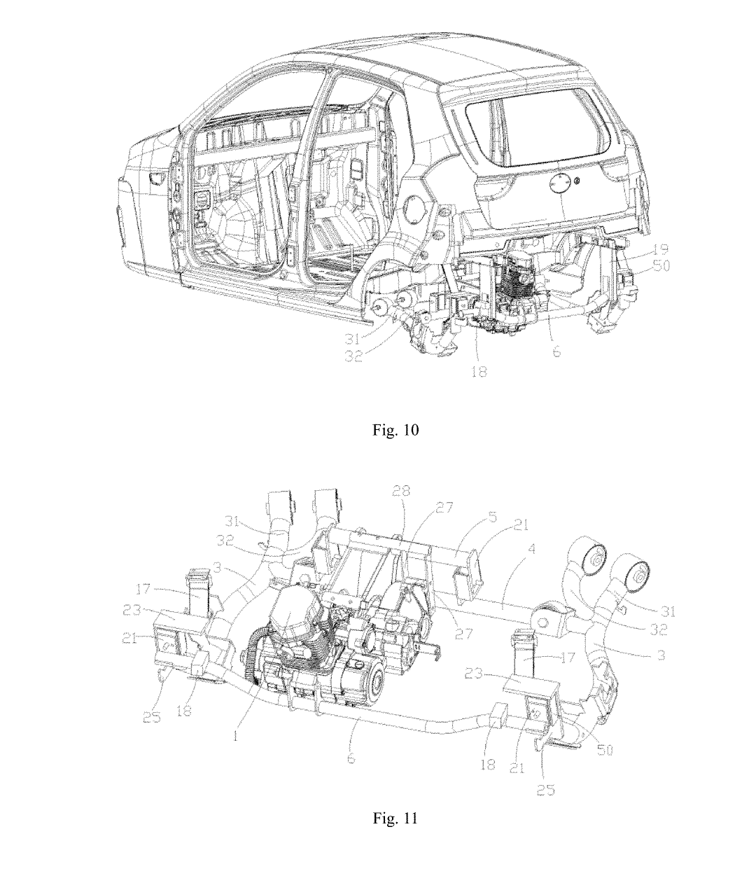

As shown in FIG. 10-11, disclosed is a motor vehicle according to a fourth embodiment of the present invention, and compared with the third embodiment, the embodiment is mainly different in the specific structures of the swaying arms 3, and rest parts can refer to those in the third embodiment, but are no longer repeated herein.

Referring to FIG. 10-11, the first end of each of the swaying arms 3 at two sides is provided with a first connector 31 and a second connector 32, and the first connector 31 and the second connector 32 at the first end of each of the swaying arms 3 are respectively connected to the load-bearing vehicle body 15 to improve the connecting firmness of the suspension and the frame or the load-bearing vehicle body.

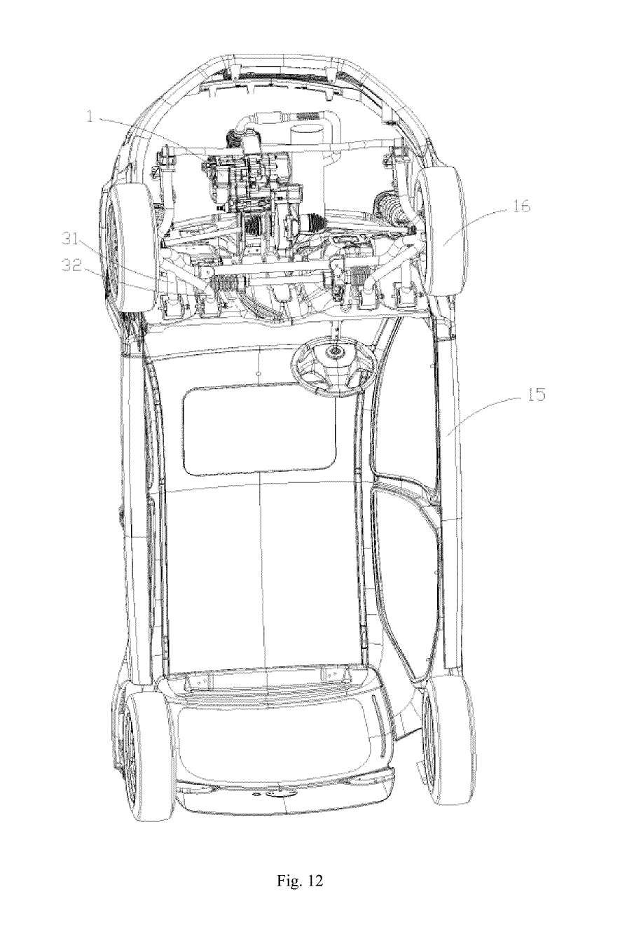

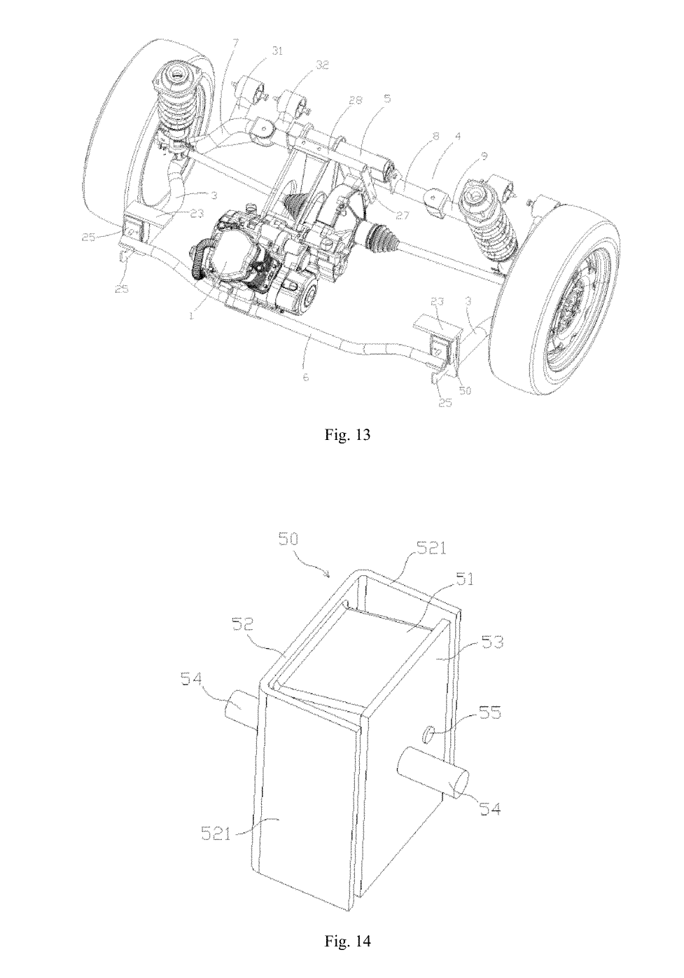

As shown in FIG. 12-13, disclosed is a motor vehicle according to a fifth embodiment of the present invention, compared with the fourth embodiment, the embodiment is mainly different in that the power system is changed to be of a front-engine structure, and rest parts can refer to those in the fourth embodiment. In addition, in the embodiment, the torsion beam 4 can comprise a left section 7 of the torsion beam, a middle section 8 of the torsion beam and a right section 9 of the torsion beam, and the specific content can refer to that in the second embodiment, but is no longer repeated herein.

In addition, it should be noted that the connecting structure which reduces the vibration effect of the power system on the vehicle body in the present invention not only is limited to the five embodiments, but also can be applied to any types of existing three-wheeled and fourth-wheeled motor vehicles. For example, the structure in the first embodiment is applied to a rear-engine rear-drive four-wheeler, or the structure in the second embodiment is applied to a front-engine front-drive inverted tricycle (a vehicle with two front wheels and one rear wheel). Meanwhile, a mounting way of the connecting structure which reduces the vibration effect of the power system on the vehicle body in the present invention can also be flexibly regulated in actual improvement work, for example, the same purpose can also be achieved by exchanging the front and rear positions of mutual connection points on the load-bearing vehicle body (or the frame) and the suspension (comprising the rotary auxiliary shafts and the shock absorbers).

Therefore, a static load and a dynamic load of the power system in the present invention are not located on the vehicle body on the shock absorbers, but rather located on the suspension frame below the shock absorbers, so that the path whereby the high frequency vibration energy of the power system is transferred to the vehicle body is extended, the high frequency vibrations of the power system are effectively attenuated and isolated, and the vibrations of the vehicle body are significantly reduced. Meanwhile, the static load and the dynamic load of the power system in the present invention are transferred from the vehicle body on the shock absorbers to the suspension frame below the shock absorbers, so that the center of gravity of the vehicle is lowered, the traveling stability of the vehicle is improved, vehicle body resonance produced under a combined action of road surface bumping and the vibrations of the power system is also effectively improved, and furthermore, the comfortable sensations of the driver and the passengers are significantly improved.

The present invention is described in detail by virtue of the specific embodiments.

However, it should be understood that the detailed description herein should not limit the essence and scope of the present invention. Various modifications to the embodiments, made after the specification is read by any one of ordinary skill in the art, belong to the protection scope of the present invention.

1. A connecting structure which reduces a vibration effect of a power system on a vehicle body, the connecting structure comprising a power system bracket and a suspension, wherein one end of the power system bracket is connected to the power system, the other end is connected to a suspension, one end of the suspension is connected to a frame or a load-bearing vehicle body, the other end is connected to an axle or wheels, and the suspension is capable of attenuating and isolating high frequency vibrations produced by the power system.

2. The connecting structure of claim 1, wherein the suspension comprises a suspension frame and shock absorbers, the suspension frame comprises swaying arms at two sides and a torsion beam connected between the swaying arms at two sides, one ends of the swaying arms are connected to the frame or the load-bearing vehicle body, the other ends are connected to the axle or the wheels, the upper ends of the shock absorbers are connected to the frame or the load-bearing vehicle body, the lower ends are connected to the suspension frame, and the power system bracket is connected to the suspension frame.

3. The connecting structure of claim 2, wherein one end of the power system is connected to the torsion beam in the suspension frame by the power system bracket, and the other end is connected to the swaying arms at two sides in the suspension frame by the power system bracket.

4. The connecting structure of claim 2, wherein the power system bracket comprises a first bracket, one end of the first bracket is connected to the power system, and the other end is connected to the torsion beam in the suspension frame.

5. The connecting structure of claim 4, wherein the buffer assemblies are arranged at the connections of the first bracket and the torsion beam to improve a shock absorption effect of the power system.

6. The connecting structure of claim 4, wherein the middle of the torsion beam is upwards bent to be arc-shaped to improve the bending resistance of the torsion beam.

7. The connecting structure of claim 6, wherein a force-bearing pulling belt is arranged below the torsion beam, and ends at two sides of the force-bearing pulling belt is respectively connected to ends at two sides of the torsion beam to improve the bending resistance of the torsion beam.

8. The connecting structure of claim 4, wherein the bearing plates are arranged at the connections of the torsion beam and the swaying arms to improve the connecting firmness of the torsion beam and the swaying arms.

9. The connecting structure of claim 4, wherein one end of each of the swaying arms is provided with a first connector and a second connector, and the first connector and the second connector are respectively connected to the frame or the load-bearing vehicle body to improve the connecting firmness of the suspension and the frame or the load-bearing vehicle body.

10. The connecting structure of claim 4, wherein the torsion beam comprises a left section of the torsion beam, a middle section of the torsion beam and a right section of the torsion beam which are connected sequentially, one end of the left section of the torsion beam is connected to the swaying arm at one side, the other end is movably connected to the middle section of the torsion beam, one end of the right section of the torsion beam is connected to the swaying arm at the other side, the other end is movably connected to the middle section of the torsion beam, and one end of the first bracket is connected to the middle section of the torsion beam.

11. The connecting structure of claim 4, wherein the power system comprises a differential assembly, and one end of the differential assembly is fixedly connected to the first bracket by supporting rods.

12. The connecting structure of claim 2, wherein the power system bracket comprises a second bracket, a stabilizer bar is connected between the swaying arms at two sides in the suspension frame, one end of the second bracket is connected to the power system, and the other end is connected to the stabilizer bar.

13. The connecting structure of claim 12, wherein a buffer assembly is arranged at the connection of the second bracket and the stabilizer bar to improve the shock absorption effect of the power system.

14. The connecting structure of claim 12, wherein the stabilizer bar comprises a left section of the stabilizer bar, a middle section of the stabilizer bar and a right section of the stabilizer bar which are connected sequentially, one end of the left section of the stabilizer bar is connected to the swaying arm at one side, the other end is movably connected to the middle section of the stabilizer bar, one end of the right section of the stabilizer bar is connected to the swaying arm at the other side, the other end is movably connected to the middle section of the stabilizer bar, and one end of the second bracket is connected to the middle section of the stabilizer bar.

15. The connecting structure of claim 2, wherein the power system bracket comprises a bracket rod, the power system is connected to the bracket rod, and two ends of the bracket rod are respectively connected to the swaying arms at two sides in the suspension frame.

16. The connecting structure of claim 15, wherein a buffer assembly is arranged at the connection of the bracket rod and each of the swaying arms to improve the shock vibration effect of the power system.

17. The connecting structure of claim 5, wherein each buffer assembly is a suspended rubber jacket or a clamping rubber block.

18. The connecting structure of claim 17, wherein the clamping rubber block is vertically arranged on a connection position and comprises a buffer block located in the middle, one side of the buffer block is provided with a U-shaped connecting groove, and the other side is provided with a connecting plate.

19. The connecting structure of claim 17, wherein the first limiting parts are arranged at the connections of the first bracket and the torsion beam and are located below the clamping rubber blocks, and when the clamping rubber block moves downwards, the first limiting part can bear and receive the clamping rubber block to limit the downward movement range of the clamping rubber block, so that the phenomenon that the clamping rubber block is damaged due to excessive deformation is avoided.

20. connecting structure of claim 17, wherein the swaying arms are also provided with second limiting parts located below the bracket rod, and when the bracket rod moves downwards, the second limiting parts can bear and receive the bracket rod to limit the downward movement range of the bracket rod.

21. The connecting structure of claim 17, wherein the frame or the load-bearing vehicle body is provided with limiting rods, the bottom ends of the limiting rods are provided with elastic blocks, the suspension frame is correspondingly provided with limiting rod baffles, and when the swaying arms move upwards, the limiting rod baffles can abut on the elastic blocks at the bottom ends of the limiting rods to limit the upward movement ranges of the swaying arms.

22. The connecting structure of claim 2, wherein anti-torsion assembly is arranged between the suspension and the frame or the load-bearing vehicle body and comprises lower stop blocks and upper stop blocks which are correspondingly arranged, the lower stop blocks are arranged on the suspension frame, the upper stop blocks are arranged on the frame or the load-bearing vehicle body, and when the left-right torsional pendulum quantity borne by the suspension is overhigh, the lower stop blocks and the upper stop blocks on the frame or the load-bearing vehicle body can be mutually stopped to play an anti-torsion role.

23. The connecting structure of claim 2, wherein the safety pulling belts are arranged between the suspension and the frame or the load-bearing vehicle body, one end of each of the safety pulling belts is connected to the suspension frame, the other end is connected to the frame or the load-bearing vehicle body, the safety pulling belts are arranged close to the shock absorbers, and the length of each of the safety pulling belts can be equal to the stretching limit length of each of the shock absorbers.

24. A motor vehicle, comprising a connecting structure which reduces a vibration effect of a power system on a vehicle body, the connecting structure comprising a power system bracket and a suspension, wherein one end of the power system bracket is connected to the power system, the other end is connected to a suspension, one end of the suspension is connected to a frame or a load-bearing vehicle body, the other end is connected to an axle or wheels, and the suspension is capable of attenuating and isolating high frequency vibrations produced by the power system.
